(19) United States
(12) Patent Application Publication
(10) Pub. No.: US 2015/0360657 A1
(43) Pub. Date: Dec. 17, 2015

(54) BRAKE TRACTION CONTROL SYSTEM AND CONTROL METHOD THEREOF

(71) Applicant: MANDO CORPORATION, Pyeongtaek-si (KR)

(72) Inventor: Seung-Yong SUNG, Ansan-si (KR)

(21) Appl. No.: 14/741,060

(22) Filed: Jun. 16, 2015

(30) Foreign Application Priority Data
Jun. 17, 2014 (KR) 10-2014-0073202

(51) Int. Cl. B60T 8/175; B60T 8/172; B60T 8/171

(52) U.S. Cl. CPC B60T 8/175; B60T 8/171; B60T 8/172

(57) ABSTRACT

A brake traction control system (BTCS) and a control method thereof are disclosed. The BTCS includes a wheel speed sensor to detect a wheel speed of each of wheels, a calculation unit to calculate a spin amount of the wheel based on the wheel speed of each wheel detected through the wheel speed sensor, and a control unit to calculate a spin amount of a control target wheel and a spin amount of a non-control target wheel opposite to the control target wheel through the calculation unit during a BTCS control, determine whether a hunting phenomenon has occurred based on the calculated spin amount of the non-control target wheel and a spin amount difference between the calculated spin amount of the control target wheel and the calculated spin amount of the non-control target wheel, and decrease a brake pressure of the control target wheel when the hunting phenomenon has occurred.

### CROSS-REFERENCE TO RELATED APPLICATION

This application claims the benefit of Korean Patent Application No. 2014-0073202, filed on Jun. 17, 2014 in the Korean Intellectual Property Office, the disclosure of which is incorporated herein by reference.

### BACKGROUND

1. Field

Embodiments of the present invention relates to a brake traction control system and a control method thereof, and more particularly, to a brake traction control system that controls a brake pressure applied to a driving wheel and a control method thereof.

2. Description of the Related Art

In general, a traction control system (TCS) is an active safety device which prevents an excessive slip of a driving wheel of a vehicle when the vehicle is launched or accelerated on a low-friction or asymmetrical road and thus improves acceleration performance and steering stability of the vehicle.

Examples of the TCS include a brake traction control system (BTCS) that controls a brake pressure in order to control a slip rate.

The BTCS is a system that exerts the TCS performance by independently controlling a speed of each driving wheel through a control of the brake pressure. A driving force is controlled by a brake torque generated by controlling solenoid valves of left and right driving wheels based on slip rates and accelerations of the driving wheels.

When a vehicle is accelerated on a road surface having little or almost no difference in frictional forces on the left and right sides, a torque transferred to a left wheel is not completely the same as that transferred to a right wheel, and also a frictional force of the left wheel to the road surface is not completely the same as that of the right wheel to the road surface. Thus, a difference in spin between the left and right wheels may occur. When the difference reaches a certain level, a brake force should be controlled appropriately.

However, a hunting phenomenon, in which even a small amount of brake force control easily causes a spin of an opposite wheel, occurs on a road surface having little or almost no difference in frictional forces on the left and right sides because a difference between frictional forces of two wheels to the road surface is small. The hunting phenomenon is a phenomenon in which, when a vehicle is accelerated on a road surface having little or almost no difference in frictional forces on the left and right sides, a brake force control for controlling a difference in spin between two wheels induces spin of an opposite wheel to cause an unnecessary brake control in the opposite wheel.

Conventionally, the hunting phenomenon could not be detected, resulting in decreases in acceleration performance and steering stability of a vehicle.

### SUMMARY

Therefore, it is an aspect of the present invention to provide a brake traction control system (BTCS) and a control method thereof in which spin tendencies of a control target wheel and an opposite wheel may be monitored during a BTCS control to rapidly and accurately determine whether a hunting phenomenon has occurred.

It is another aspect of the present invention to provide a brake traction control system and a control method thereof in which, when the hunting phenomenon has occurred, the hunting phenomenon may be early removed using a brake pressure control appropriate for the hunting phenomenon that has occurred in the control target wheel.

Additional aspects of the invention will be set forth in part in the description which follows and, in part, will be obvious from the description, or may be learned by practice of the invention.

In accordance with one aspect of the present invention, a brake traction control system (BTCS) includes: a wheel speed sensor configured to detect a wheel speed of each of wheels; a calculation unit configured to calculate a spin amount of the wheel based on the wheel speed of each wheel detected through the wheel speed sensor; and a control unit configured to calculate a spin amount of a control target wheel and a spin amount of a non-control target wheel opposite to the control target wheel through the calculation unit during a BTCS control, determine whether a hunting phenomenon has occurred based on the calculated spin amount of the non-control target wheel and a spin amount difference between the calculated spin amount of the control target wheel and the calculated spin amount of the non-control target wheel, and decrease a brake pressure of the control target wheel when the hunting phenomenon has occurred.

The control unit may determine that the hunting phenomenon has occurred when the calculated spin amount C1 of the non-control target wheel is greater than a predetermined first value TP1 and an absolute value C2 of the spin amount difference is greater than a predetermined second value TP2.

The control unit may determine that the hunting phenomenon has occurred when the calculated spin amount C1 of the non-control target wheel is greater than a predetermined first value TP1 and a difference value ΔC2 obtained by subtracting an absolute value of a spin amount difference in a previous control period from an absolute value of a spin amount difference in a current control period is less than zero.

The control unit may decrease the brake pressure of the control target wheel to substantially zero when the hunting phenomenon has occurred.

When the brake pressure of the control target wheel is controlled again in a next control period after the brake pressure of the control target wheel is decreased to substantially zero, an initial brake pressure amount may be decreased to be less than an initial brake pressure amount in the previous control period.

In accordance with another aspect of the present invention, a brake traction control system (BTCS) includes: a wheel speed sensor configured to detect a wheel speed of each of wheels; a calculation unit configured to calculate a spin amount of the wheel based on the wheel speed of each wheel detected through the wheel speed sensor; and a control unit configured to calculate a spin amount of a control target wheel and a spin amount of a non-control target wheel through the calculation unit during a BTCS control and decrease a brake pressure of the control target wheel based on the calculated spin amount of the non-control target wheel and a spin amount difference between the calculated spin amount of the control target wheel and the calculated spin amount of the non-control target wheel.

The control unit may decrease the brake pressure of the control target wheel when the calculated spin amount C1 of the non-control target wheel is greater than a predetermined first value TP1 and an absolute value C2 of the spin amount difference is greater than a predetermined second value TP2.

The control unit may decrease the brake pressure of the control target wheel when the calculated spin amount C1 of the non-control target wheel is greater than a predetermined first value TP1 and a difference value ΔC2 obtained by subtracting an absolute value of a spin amount difference in a previous control period from an absolute value of a spin amount difference in a current control period is less than zero.

In accordance with still another aspect of the present invention, a control method of a brake traction control system (BTCS) includes: calculating a spin amount of a control target wheel during a BTCS control; calculating a spin amount of a non-control target wheel opposite to the control target wheel; determining whether a hunting phenomenon has occurred based on the spin amount of the non-control target wheel and a spin amount difference between the spin amount of the control target wheel and the spin amount of the non-control target wheel; and decreasing a brake pressure of the control target wheel when the hunting phenomenon has occurred.

The determining of whether the hunting phenomenon has occurred may include determining that the hunting phenomenon has occurred when the calculated spin amount C1 of the non-control target wheel is greater than a predetermined first value TP1 and an absolute value C2 of the spin amount difference is greater than a predetermined second value TP2.

The determining of whether the hunting phenomenon has occurred may include determining that the hunting phenomenon has occurred when the calculated spin amount C1 of the non-control target wheel is greater than a predetermined first value TP1 and a difference value ΔC2 obtained by subtracting an absolute value of a spin amount difference in a previous control period from an absolute value of a spin amount difference in a current control period is less than zero.

The decreasing of the brake pressure of the control target wheel may include decreasing the brake pressure of the control target wheel to substantially zero.

The control method may further include decreasing an initial brake pressure amount to be less than an initial brake pressure amount in the previous control period when the brake pressure of the control target wheel is controlled again in a next control period after the brake pressure of the control target wheel is decreased to substantially zero.

The decreasing of the brake pressure of the control target wheel may include decreasing an initial brake pressure amount of the control target wheel and decreasing the brake pressure of the control target wheel to substantially zero when the spin amount of the non-control target wheel is greater than a predetermined value.

In accordance with still another aspect of the present invention, a control method of a brake traction control system (BTCS) includes: calculating a spin amount of a control target wheel and a spin amount of a non-control target wheel during a BTCS control; calculating a spin amount difference between the calculated spin amount of the control target wheel and the calculated spin amount of the non-control target wheel; and decreasing a brake pressure of the control target wheel to substantially zero when the calculated spin amount of the non-control target wheel is greater than a predetermined first value and an absolute value of the calculated spin amount difference is greater than a predetermined second value.

In accordance with still another aspect of the present invention, a control method of a brake traction control system (BTCS) includes: calculating a spin amount of a control target wheel and a spin amount of a non-control target wheel during a BTCS control; calculating a spin amount difference between the calculated spin amount of the control target wheel and the calculated spin amount of the non-control target wheel; and decreasing a brake pressure of the control target wheel to substantially zero when the calculated spin amount of the non-control target wheel is greater than a predetermined first value and a difference value obtained by subtracting an absolute value of a spin amount difference in a previous control period from an absolute value of a spin amount difference in a current control period is less than zero.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a hydraulic circuit diagram of a brake traction control system according to an embodiment of the present invention;

FIG. 2 is a schematic control block diagram of a brake traction control system according to an embodiment of the present invention;

FIG. 3 is a view for describing an operation of a control unit of a brake traction control system according to an embodiment of the present invention;

FIG. 4 is a view for describing a hunting phenomenon in a brake traction control system according to an embodiment of the present invention;

FIG. 5 is a view for describing an operation of determining whether a hunting phenomenon occurs in a brake traction control system according to an embodiment of the present invention;

FIG. 6 is a view for describing an operation of controlling a brake pressure of a wheel to be controlled when a hunting phenomenon occurs in a brake traction control system according to an embodiment of the present invention;

FIG. 7 is a control flowchart of a control method of a brake traction control system according to an embodiment of the present invention; and

FIG. 8 is a control flowchart for describing an operation of controlling a brake pressure of a wheel to be controlled when a hunting phenomenon occurs in a brake traction control system according to an embodiment of the present invention.

### DETAILED DESCRIPTION

Hereinafter, embodiments of the present invention will be described in detail with reference to the accompanying drawings. The exemplary embodiments introduced herein are provided to make disclosed contents thorough and complete and sufficiently transfer the spirit of the present invention to those skilled in the art. The present invention may, however, be embodied in different forms and should not be construed as limited to the embodiments set forth herein. In the drawings, portions unrelated to description will be omitted in order not to obscure the present invention, and the width, length, thickness, etc. of components may be exaggerated or reduced for the sake of convenience. Like reference numerals refer to like elements throughout.

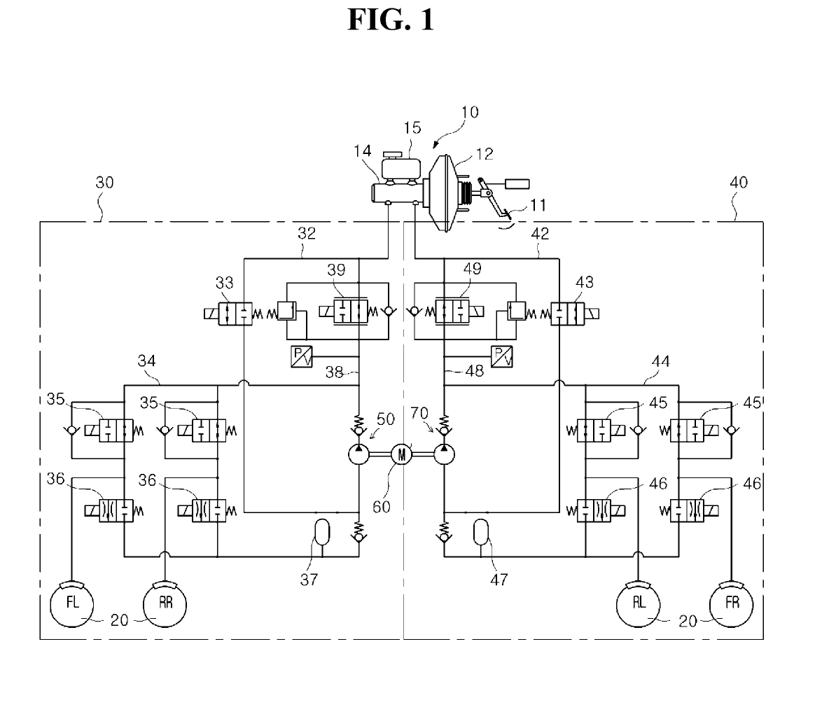

FIG. 1 is a hydraulic circuit diagram of a brake traction control system according to an embodiment of the present invention.

Referring to FIG. 1, a brake traction control system (BTCS) includes a master cylinder assembly 10 configured to generate a hydraulic pressure by manipulation of a brake pedal, a plurality of wheel brakes 20 configured to brake a wheel using the hydraulic pressure provided from the master cylinder assembly 10, a first and second hydraulic circuits 30 and 40 configured to connect the master cylinder assembly 10 and the plurality of wheel brakes 20, and a first and second pumps 50 and 70 installed on the first and second hydraulic circuits 30 and 40 and driven by a motor 60.

The master cylinder assembly 10 includes a brake pedal 11 operated by manipulation of a driver, a booster 12 configured to amplify an operating force of the brake pedal 11, a master cylinder 14 configured to generate a hydraulic pressure by a pressure applied by the booster 12, and an oil reservoir 15 configured to store the oil.

The wheel brake 20 is used to brake wheels FL, FR, RL, and RR using the hydraulic pressure generated by the master cylinder assembly 10. The wheel brake 20 may include a caliper device that includes a disc configured to rotate along with a wheel, a pad configured to press the disc with the hydraulic pressure at both ends, and a piston configured to move the pad back and forth.

The first and second hydraulic circuits 30 and 40 are configured to connect the master cylinder assembly 10 and the plurality of wheel brakes 20 to provide the hydraulic pressure generated by the master cylinder assembly 10. The first and second hydraulic circuits 30 and 40 form respective closed-loop circuits in which brake oil is circulated and include a first and second pumps 50 and 70 operated by one motor 60, respectively. In an embodiment of the present invention, each of the first hydraulic circuit 30 and the second hydraulic circuit 40 connects and controls two wheel brakes. Although the second hydraulic circuit 40 is configured independently of the first hydraulic circuit 30, the second hydraulic circuit 40 has the same arrangement as the first hydraulic circuit 30. Thus, a detailed description thereof will be omitted.

The first hydraulic circuit 30 includes an intake line 32 that connects the master cylinder 14 and an intake side of the first pump 50 during a BTCS control. A normal-close-type solenoid valve 33 is installed on the intake line 32. The intake line 32 is branched to be connected with the intake side of the first pump 50. A discharge side of the first pump 50 is connected with the master cylinder 14 through a discharge line 38. A check valve that prevents backflow is installed in the discharge side of the first pump 50. A normal-open-type solenoid valve 39 is installed in the discharge line 38.

A brake line 34 is branched from the discharge line 38 provided to the discharge side of the first pump 50. The brake oil of the master cylinder 14 may also be transferred toward the wheel brake 20 through the solenoid valve 39 via the branched brake line 34. For example, the brake line 34 transfers the brake oil to the intake side of the first pump 50 during the BTCS control. The brake line 34 includes a plurality of solenoid valves 35 and 36 configured to transfer and discharge the brake oil to the wheel brake 20 and a low-pressure accumulator 37 configured to temporarily store the brake oil.

A flow path of the second hydraulic circuit 40 has the same structure and function as that of the first hydraulic circuit 30, and only the reference numbers are different.

When a slip occurs in a driving wheel, the BTCS having the above-described configuration performs the BTCS control to close the solenoid valve 39 and control operations of the solenoid valves 35 and 45 and operations of the solenoid valves 36 and 46 such that a slip rate reaches a reference slip rate, thereby increasing, maintaining, and decreasing the brake pressure of the driving wheel.

Usually, when a driver steps on the brake pedal 11, the brake pressure of the driving wheel is directly transferred to the wheel brake 20.

When increasing a brake pressure of the wheel brake 20, the BTCS opens the solenoid valves 35 and 45, closes the solenoid valves 36 and 46, and then drives the pumps 50 and 70 to supply the brake oil having the increased brake pressure to the wheel brake 20. This increases the brake pressure of the wheel brake 20.

When maintaining the brake pressure of the wheel brake 20, the BTCS closes the solenoid valves 35 and 45 and the solenoid valves 36 and 46 to maintain the brake pressure of the wheel brake 20.

When decreasing the brake pressure of the wheel brake 20, the BTCS opens the solenoid valves 36 and 46 to allow the brake oil of the wheel brake 20 to be fed back to the oil reservoir 15 along the intake line 32. This decreases the brake pressure of the wheel brake 20.

In general, the BTCS controls a driving force by a brake torque generated by controlling solenoid valves of left and right driving wheels based on slip rates and accelerations of the driving wheels. That is, when the slip exceeds a predetermined reference slip rate, the BTCS starts the BTCS control by generating the brake pressure and controls the driving force by changing a control torque by using variations of the slip and acceleration of the driving wheel to adjust times for increasing, maintaining, and decreasing the pressure such that the slip of the driving wheel may be maintained within a predetermined slip rate range.

As described above, a hunting phenomenon in which even a small amount of brake force control easily and repeatedly causes a spin of an opposite wheel since a difference between frictional forces of two wheels to the road surface is small occurs on a road surface having little or almost no difference in frictional forces on the left and right sides. The hunting phenomenon may decrease acceleration performance and steering stability of the vehicle.

Accordingly, according to an embodiment of the present invention, it is possible to rapidly and accurately determine occurrence of the hunting phenomenon by monitoring spin tendencies of a wheel to be controlled (hereinafter referred to as a control target wheel) and an opposite wheel (hereinafter referred to as a non-control target wheel) during a BTCS control. This can minimize decreases in the acceleration performance and steering stability of the vehicle. Furthermore, it is also possible to early and effectively remove the hunting phenomenon by adjusting a brake pressure of the control target wheel appropriately for the hunting phenomenon.

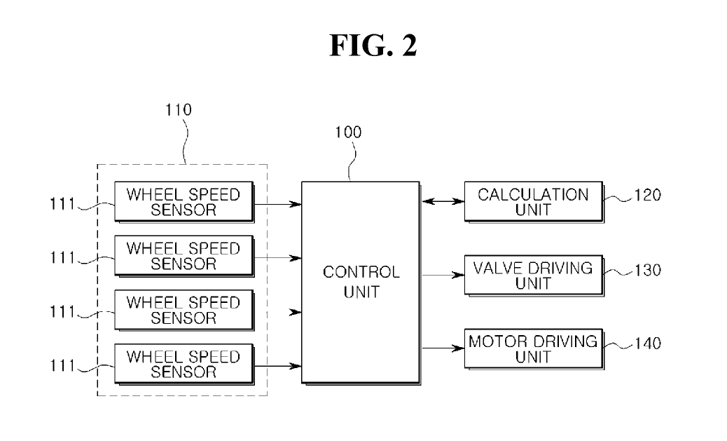

FIG. 2 is a schematic control block diagram of a brake traction control system according to an embodiment of the present invention.

Referring to FIG. 2, the BTCS includes a control unit 100 configured to control an overall control of the BTCS.

The control unit 100 is electrically connected with a sensing unit 110 at an input side.

The sensing unit 110 includes a wheel speed sensor 111 provided to each wheel and configured to detect a wheel speed of the wheel. In addition, the sensing unit may include various types of sensors that are needed for the BTCS control, such as a steering angle sensor configured to detect a steering angle of a steering wheel and an acceleration sensor configured to detect a longitudinal acceleration. In addition, the sensing unit 110 may include a sensor configured to detect an amount of spin of each wheel.

The control unit 100 is electrically connected with a calculation unit 120, a valve driving unit 130, and a motor driving unit 140 at an output side.

The calculation unit 120 calculates the amount of spin of each wheel. The calculation unit 120 calculates slip rates based on speeds of wheels that are detected by the respective wheel speed sensors 111 and detects whether there is spin on the control target wheel and the non-control target wheel opposite to the control target wheel and the amounts thereof based on the calculated slip rates. The calculation unit 120 may calculate the amount of spin of each of the wheels FR, FL, RL, and RR by subtracting a speed of a vehicle from a speed of the wheel.

The valve driving unit 130 drives the solenoid valves 33 and 43, the solenoid valves 35 and 45, the solenoid valves 36 and 46, and the solenoid valves 39 and 49. The valve driving unit 130 may turn on or off various types of solenoid valves and may control an electric current supplied to each valve to adjust a degree of opening thereof.

The motor driving unit 140 drives the motor 60.

The control unit 100 calculates the amounts of spin of the control target wheel and non-control target wheel opposite to the control target wheel through the calculation unit 120 during the BTCS control.

Furthermore, the control unit 100 calculates a spin amount difference between the amounts of spin of the control target wheel and the non-control target wheel and determines whether the hunting phenomenon has occurred on the basis of the calculated spin amount difference between the amounts of spin of the control target wheel and the non-control target wheel and the calculated amount of spin of the non-control target wheel.

If the hunting phenomenon has occurred, the control unit 100 reduces the brake pressure of the control target wheel.

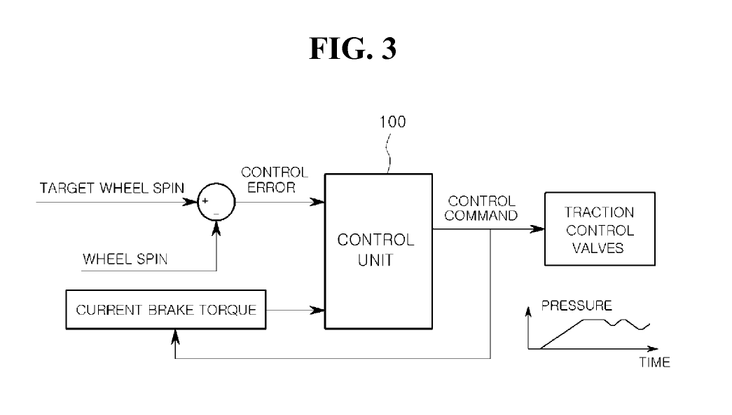

FIG. 3 is a view for describing an operation of a control unit of a brake traction control system according to an embodiment of the present invention.

Referring to FIG. 3, when a control is performed by the BTCS, the control unit 100 generates a control command according to a current brake toque and a control error which is a difference between wheel spin and target wheel spin and drives the traction control valves 35, 36, 45, and 46 through the valve driving unit 130 according to the generated control command to control operations of the traction control valves. Thereby, the control unit 100 adjusts the brake pressure of the wheel brake 20. That is, the brake pressure of the corresponding wheel brake is controlled such that currently generated spin amounts of left and right wheels may converge toward the target spin amount.

However, there is a time difference between a brake pressure instructed by characteristics of pressure control and a brake pressure actually formed in a hydraulic circuit.

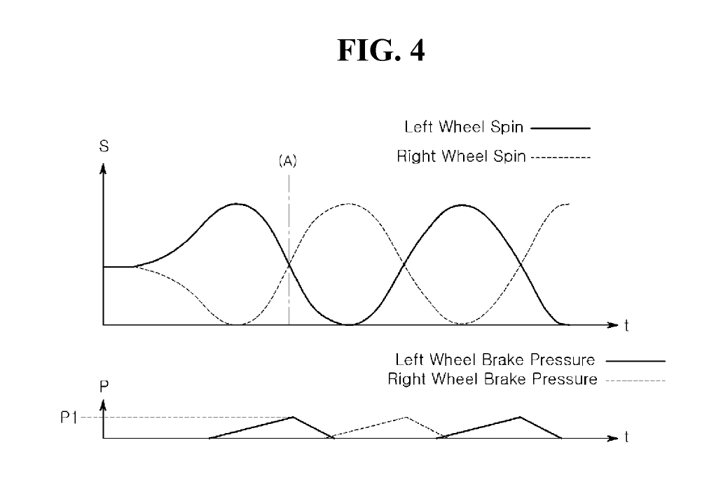

FIG. 4 is a view for describing a hunting phenomenon in a brake traction control system according to an embodiment of the present invention.

Referring to FIG. 4, a vertical axis indicates amounts of spin S and pressure P, and a horizontal axis indicates time t. The solid line indicates spin of a left wheel of which a brake pressure is controlled (left wheel spin), and the dotted line indicates spin of a right wheel opposite to the left wheel (right wheel spin). In addition, pressure P is represented in the same manner as spin S.

When the spin of the wheel that is not controlled at time (A) (right wheel spin) is equal to the spin of the wheel that is controlled (left wheel spin), a brake pressure remains in a hydraulic circuit even when the brake pressure control is completed. The remaining brake pressure increases the spin of the opposite wheel (right wheel spin). This results in the hunting phenomenon, which may decrease acceleration performance and steering stability of the vehicle.

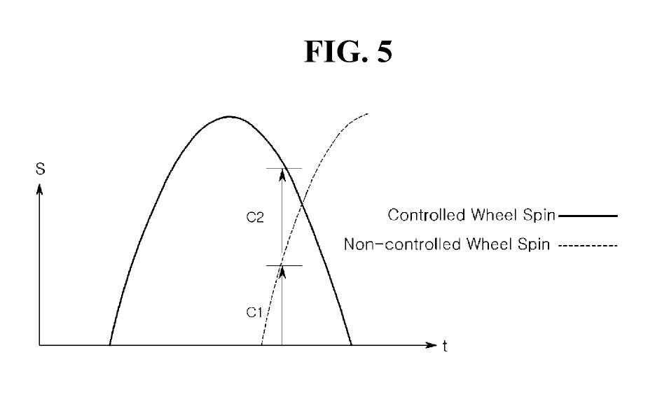

FIG. 5 is a view for describing an operation of determining whether a hunting phenomenon occurs in a brake traction control system according to an embodiment of the present invention.

Referring to FIG. 5, before the amounts of spin of two wheels are reversed, it should be determined whether the hunting phenomenon has occurred. The determination of the hunting phenomenon uses a method of monitoring spin tendencies of the two wheels.

A vertical axis indicates amounts of spin S and pressure P, and a horizontal axis indicates time t. The solid line indicates spin of a wheel of which a brake pressure is controlled (controlled wheel spin), and the dotted line indicates spin of a wheel of which the brake pressure is not controlled and which is positioned in opposite to the wheel of which the pressure is controlled (non-controlled wheel spin).

C1 indicates the amount of spin of a wheel not to be controlled (hereinafter referred to as a spin amount of a non-control target wheel). C1 may be expressed as Equation (1) below:

C₁-Spin_{Non-controlled-wheel}. (1)

In addition, C2 indicates an absolute value of a spin amount difference between the amount of spin of a wheel to be controlled (hereinafter referred to as a spin amount of a control target wheel) and the spin amount of the non-control target wheel. C2 may be expressed as Equation (2) below:

C₂=|Spin_{controlled-wheel}-Spin_{Non-controlled-wheel}|. (2)

If C1 and C2 satisfy at least one of Equation (3) and Equation (4) below, it is determined that the hunting phenomenon has occurred.

(C₁>TP₁) AND (C₂>TP₂) (3)

(C₁>TP₁) AND (ΔC₂<0) (4)

Here, TP1 is a predetermined first value, and TP2 is a predetermined second value.

When C1 and C2 satisfy a condition of Equation (3) or a condition of Equation (4) for a certain time, it is determined that the hunting phenomenon has occurred. Accordingly, before the spin amount of the non-control target wheel becomes greater than the spin amount of the control target wheel, it can be previously determined whether the hunting phenomenon has occurred.

As expressed in Equation (3), when the spin amount C1 of the non-control target wheel is greater than the predetermined first value TP1 and the absolute value C2 of the spin amount difference is greater than the predetermined second value TP2, it may be determined that the hunting phenomenon has occurred.

As expressed in Equation (4), when the spin amount C1 of the non-control target wheel is greater than the predetermined first value TP1 and a difference value ΔC2 (variation between the spin amounts) obtained by subtracting an absolute value C2_previous of a spin amount difference in a previous control period from an absolute value C2_current of a spin amount difference in a current control period is less than zero (that is, a negative number), it may be determined that the hunting phenomenon has occurred.

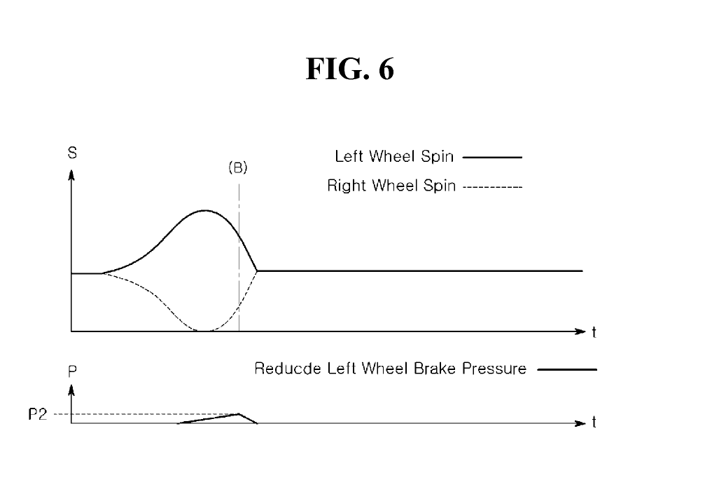

FIG. 6 is a view for describing an operation of controlling a brake pressure of a wheel to be controlled when a hunting phenomenon occurs in a brake traction control system according to an embodiment of the present invention.

Referring to FIG. 6 along with FIG. 4, a vertical axis indicates amounts of spin S and pressure P, and a horizontal axis indicates time t. The solid line indicates a left wheel spin which is an example of a control target wheel, and a dotted line indicates a right wheel spin which is a non-control target wheel corresponding to the control target wheel. In addition, pressure P is represented in the same manner as spin S.

If the hunting phenomenon has occurred in time (B), a brake pressure of the left wheel which is the control target wheel is reduced. Thus, since a remaining brake pressure is previously lowered, the lowered remaining brake pressure can prevent the right wheel spin, which is spin of the non-control target wheel, from being increased. This can prevent repetition of the hunting phenomenon, thus enhancing acceleration performance and steering stability of the vehicle.

When the hunting phenomenon has occurred, one of two different control strategies is applied, or both thereof are mixed and applied.

First, when spin has occurred in the non-control target wheel, the bake pressure of the control target wheel is decreased to substantially zero.

Second, when the brake pressure is controlled again, an initial brake pressure amount is lowered.

When spin has occurred again on the same road surface after the hunting phenomenon, the brake pressure may be controlled. In this case, if the control is performed using the same brake pressure as before, it is easy for the hunting phenomenon to occur again. Accordingly, under a condition that the hunting phenomenon has occurred, when the non-control target wheel has even a small amount of spin while a brake pressure is controlled, the brake pressure is decreased to zero immediately, thus preventing the hunting phenomenon from occurring.

Also, when the brake pressure control starts again while the hunting phenomenon has occurred, the control is performed with a lower pressure, thus increasing responsiveness that allows the break pressure to be zero when spin occurs in the non-control target wheel. When the hunting phenomenon has occurred, in order to reduce a spin amount difference between two left and right wheels, an initial brake control is performed using a pressure lower than a pressure applied to a road surface (Split-mu road surface) having different road surface friction coefficients of left and right wheels. For example, when the brake pressure of the control target wheel is controlled again in a next control period after the brake pressure of the control target wheel is decreased to substantially zero, an initial brake pressure amount may be decreased to be less than an initial brake pressure amount in the previous control period.

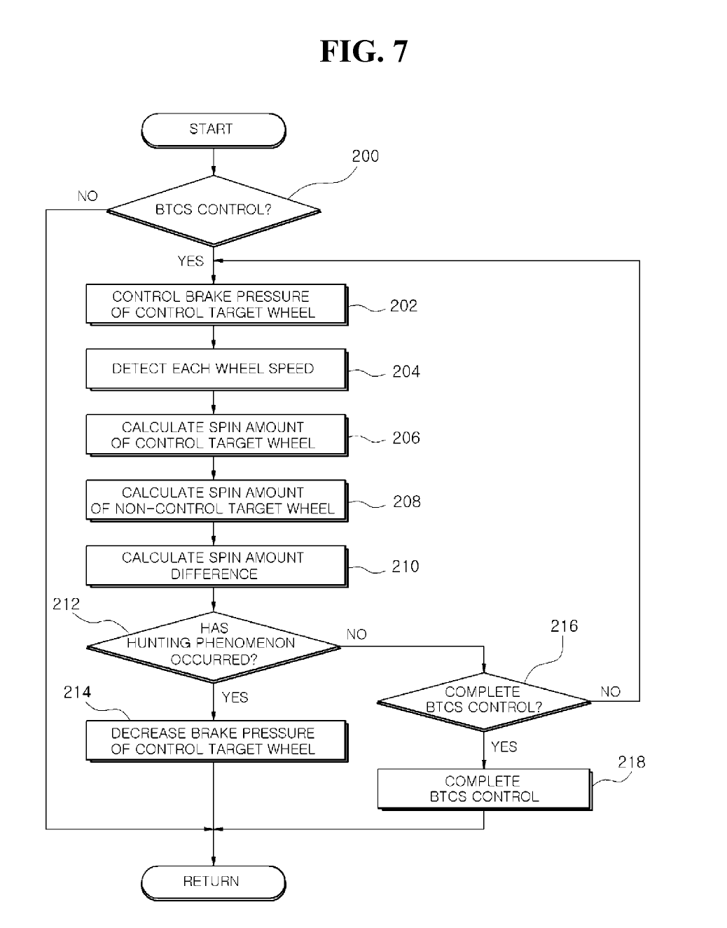

FIG. 7 is a control flowchart of a control method of a brake traction control system according to an embodiment of the present invention.

Referring to FIG. 7, the control unit 100 determines whether a control of the BTCS is started (200). In this case, the control unit 100 may calculate a slip rate of each of wheels according to a wheel speed of each wheel and determine that that the control of the BTCS is started when the calculated slip rate is greater than a predetermined reference slip rate.

When the control of the BTCS is started, the control unit 100 starts the BTCS control to operate various types of valves and motors through the valve driving unit 130 and the motor driving unit 140 to control a brake pressure of a control target wheel (202).

The control unit 100 detects a wheel speed through each of the wheel speed sensors 111 of the sensing unit 110 (204).

The control unit 100 calculates a spin amount of the control target wheel using information on the detected wheel speed (206). In addition, the control unit 100 uses the information on the detected wheel speed to calculate a spin amount C1 of the non-control target wheel (208).

In addition, the control unit 100 calculates a spin amount difference C2 between the spin rate of the control target wheel and the spin rate of the non-control target wheel (210).

The control unit 100 uses the spin amount C1 of the non-control target wheel and the spin amount difference C2 to determine whether the hunting phenomenon has occurred (212). The above-described Equation (3) and Equation (4) are used to determine whether the hunting phenomenon has occurred.

When the hunting phenomenon has occurred, the control unit 100 reduces a brake pressure of the control target wheel (214). In this case, under a condition that the hunting phenomenon has occurred, when the non-control target wheel has even a small amount of spin while a brake pressure is controlled, the brake pressure is decreased to zero immediately, thus preventing the hunting phenomenon from occurring.

On the contrary, when the hunting phenomenon does not occur, it is determined whether the BTCS control is completed (216). When the BTCS control is completed, the BTCS completes the control (218). If the BTCS control is not completed, the control flow returns to operation mode 202 and performs next operation modes.

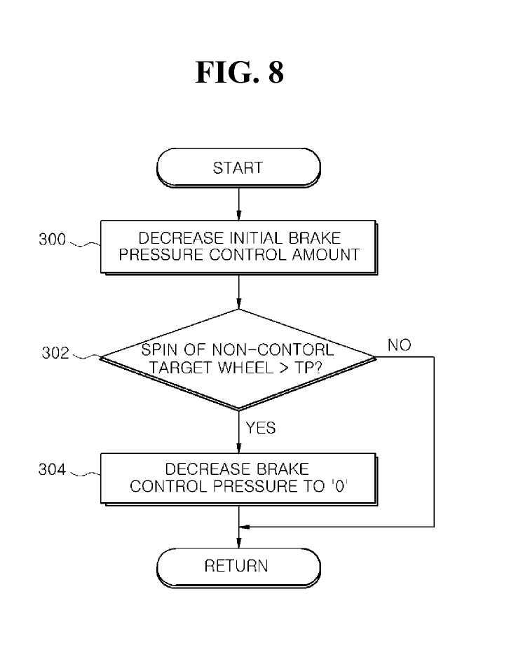

FIG. 8 is a control flowchart for describing an operation of controlling a brake pressure of a wheel to be controlled when a hunting phenomenon occurs in a brake traction control system according to an embodiment of the present invention.

Referring to FIG. 8, when the hunting phenomenon has occurred, the control unit 100 decreases an initial brake pressure control amount of the control target wheel (300) (e.g., decreases P1 of FIG. 4 to P2 of FIG. 6). The control unit 100 controls the brake pressure of the control target wheel according to the decreased brake pressure control amount.

In addition, the control unit 100 determines whether the spin amount of the non-control target wheel exceeds a predetermined value TP (302).

If the determination result of operation mode 302 is that the spin amount of the non-control target wheel exceeds the predetermined value TP, the control unit 100 decreases the brake control pressure of the control target wheel to zero immediately (304). On the contrary, if the determination result of operation mode 302 is that the spin amount of the non-control target wheel is equal to or less than the predetermined value TP, the control unit 100 returns a predetermined routine.

According to an aspect of the present invention, it is possible to minimize decreases in acceleration performance and steering stability of a vehicle through an appropriate pressure control by monitoring spin tendencies of a control target wheel and an opposite wheel during a BTCS control to determine whether the hunting phenomenon has occurred.

According to another embodiment of the present invention, it is possible to rapidly and accurately determine occurrence of the hunting phenomenon by monitoring spin tendencies of a control target wheel and an opposite wheel during the BTCS control.

According to still another embodiment of the present invention, it is also possible to early and effectively remove the hunting phenomenon by adjusting a brake pressure of a control target wheel appropriately for the hunting phenomenon.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A brake traction control system (BTCS) comprising:
a wheel speed sensor configured to detect a wheel speed of each of wheels;
a calculation unit configured to calculate a spin amount of the wheel based on the wheel speed of each wheel detected through the wheel speed sensor; and
a control unit configured to calculate a spin amount of a control target wheel and a spin amount of a non-control target wheel opposite to the control target wheel through the calculation unit during a BTCS control, determine whether a hunting phenomenon has occurred based on the calculated spin amount of the non-control target wheel and a spin amount difference between the calculated spin amount of the control target wheel and the calculated spin amount of the non-control target wheel, and decrease a brake pressure of the control target wheel when the hunting phenomenon has occurred.

2. The brake traction control system of claim 1, wherein the control unit determines that the hunting phenomenon has occurred when the calculated spin amount (C1) of the non-control target wheel is greater than a predetermined first value (TP1) and an absolute value (C2) of the spin amount difference is greater than a predetermined second value (TP2).

3. The brake traction control system of claim 1, wherein the control unit determines that the hunting phenomenon has occurred when the calculated spin amount (C1) of the non-control target wheel is greater than a predetermined first value (TP1) and a difference value (ΔC2) obtained by subtracting an absolute value of a spin amount difference in a previous control period from an absolute value of a spin amount difference in a current control period is less than zero.

4. The brake traction control system of claim 1, wherein the control unit decreases the brake pressure of the control target wheel to substantially zero when the hunting phenomenon has occurred.

5. The brake traction control system of claim 4, wherein, when the brake pressure of the control target wheel is controlled again in a next control period after the brake pressure of the control target wheel is decreased to substantially zero, an initial brake pressure amount is decreased to be less than an initial brake pressure amount in the previous control period.

6. A brake traction control system (BTCS) comprising:
a wheel speed sensor configured to detect a wheel speed of each of wheels;
a calculation unit configured to calculate a spin amount of the wheel based on the wheel speed of each wheel detected through the wheel speed sensor; and
a control unit configured to calculate a spin amount of a control target wheel and a spin amount of a non-control target wheel through the calculation unit during a BTCS control and decrease a brake pressure of the control target wheel based on the calculated spin amount of the non-control target wheel and a spin amount difference between the calculated spin amount of the control target wheel and the calculated spin amount of the non-control target wheel.

7. The brake traction control system of claim 6, wherein the control unit decreases the brake pressure of the control target wheel when the calculated spin amount (C1) of the non-control target wheel is greater than a predetermined first value (TP1) and an absolute value (C2) of the spin amount difference is greater than a predetermined second value (TP2).

8. The brake traction control system of claim 6, wherein the control unit decreases the brake pressure of the control target wheel when the calculated spin amount (C1) of the non-control target wheel is greater than a predetermined first value (TP1) and a difference value (ΔC2) obtained by subtracting an absolute value of a spin amount difference in a previous control period from an absolute value of a spin amount difference in a current control period is less than zero.

9. A control method of a brake traction control system (BTCS), the control method comprising:
calculating a spin amount of a control target wheel during a BTCS control;
calculating a spin amount of a non-control target wheel opposite to the control target wheel;
determining whether a hunting phenomenon has occurred based on the spin amount of the non-control target wheel and a spin amount difference between the spin amount of the control target wheel and the spin amount of the non-control target wheel; and
decreasing a brake pressure of the control target wheel when the hunting phenomenon has occurred.

10. The control method of claim 9, wherein the determining of whether the hunting phenomenon has occurred comprises determining that the hunting phenomenon has occurred when the calculated spin amount (C1) of the non-control target wheel is greater than a predetermined first value (TP1) and an absolute value (C2) of the spin amount difference is greater than a predetermined second value (TP2).

11. The control method of claim 9, wherein the determining of whether the hunting phenomenon has occurred comprises determining that the hunting phenomenon has occurred when the calculated spin amount (C1) of the non-control target wheel is greater than a predetermined first value (TP1) and a difference value (ΔC2) obtained by subtracting an absolute value of a spin amount difference in a previous control period from an absolute value of a spin amount difference in a current control period is less than zero.

12. The control method of claim 9, wherein the decreasing of the brake pressure of the control target wheel comprises decreasing the brake pressure of the control target wheel to substantially zero.

13. The control method of claim 12, further comprising decreasing an initial brake pressure amount to be less than an initial brake pressure amount in the previous control period when the brake pressure of the control target wheel is controlled again in a next control period after the brake pressure of the control target wheel is decreased to substantially zero.

14. The control method of claim 9, wherein the decreasing of the brake pressure of the control target wheel comprises decreasing an initial brake pressure amount of the control target wheel and decreasing the brake pressure of the control target wheel to substantially zero when the spin amount of the non-control target wheel is greater than a predetermined value.

15. A control method of a brake traction control system (BTCS), the control method comprising:
calculating a spin amount of a control target wheel and a spin amount of a non-control target wheel during a BTCS control;
calculating a spin amount difference between the calculated spin amount of the control target wheel and the calculated spin amount of the non-control target wheel; and
decreasing a brake pressure of the control target wheel to substantially zero when the calculated spin amount of the non-control target wheel is greater than a predetermined first value and an absolute value of the calculated spin amount difference is greater than a predetermined second value.

16. A control method of a brake traction control system (BTCS), the control method comprising:
calculating a spin amount of a control target wheel and a spin amount of a non-control target wheel during a BTCS control;
calculating a spin amount difference between the calculated spin amount of the control target wheel and the calculated spin amount of the non-control target wheel; and
decreasing a brake pressure of the control target wheel to substantially zero when the calculated spin amount of the non-control target wheel is greater than a predetermined first value and a difference value obtained by subtracting an absolute value of a spin amount difference in a previous control period from an absolute value of a spin amount difference in a current control period is less than zero.
